(19) United States
(12) Patent Application Publication
(10) Pub. No.: US 2014/0118012 A1
(43) Pub. Date: May 1, 2014

(54) Sensor Device as Well as Method for Proximity and Touch Detection

(71) Applicants: Holger Erkens, Dusscldorf (DE); Claus Kaltner, Unterbachern (DE)

(72) Inventors: Holger Erkens, Dusscldorf (DE); Claus Kaltner, Unterbachern (DE)

(21) Appl. No.: 13/822,022

(22) PCT Filed: Aug. 31, 2011
(86) PCT No.: PCT/EP2011/065064

§ 371 Date: Dec. 23, 2013

(30) Foreign Application Priority Data
Sep. 9, 2010 (DE) 10 2010 044 820.6

(51) Int. Cl. G01N 27/22

(52) U.S. Cl. CPC G01N 27/22
USPC 324/684

(57) ABSTRACT

A sensor device has a first electrode structure and a second electrode structure, the first electrode structure has a transmitting electrode, a compensation electrode and a reception electrode and the second electrode structure has a field transmission electrode and at least one field sensing electrode. The first electrode structure is adapted to detect a gripping of an electric hand-held device, whereas the second electrode structure is adapted to detect an approach of a finger to the second electrode structure, for example of the hand gripping the hand-held device.

### CROSS-REFERENCE TO RELATED APPLICATIONS

This application is a U.S. National Stage Application of International Application No. PCT/EP2011/065064 filed Aug. 31, 2011, which designates the United States of America, and claims priority to DE Application No. 10 2010 044 820.6 filed Sep. 9, 2010, the contents of which are hereby incorporated by reference in their entirety.

### TECHNICAL FIELD

The invention relates to a sensor device which can be arranged at an electric hand-held device and which is adapted to detect as to whether the electric hand-held device is gripped by a hand and as to whether the electric hand-held device is approached by a hand. Moreover the invention relates to a method for the proximity and touch detection with a sensor device according to the invention. Moreover the invention concerns a hand-held device with a sensor device according to the invention. The hand-held device can be for example a mobile phone, a computer mouse, a remote control, an input means for a game console, a mobile computer or similar.

### BACKGROUND

On an electric device, for example an electrical hand-held device, always means 20 for operating the electric device are needed. In case of an electric hand-held device, for example a mobile phone, it is usual, to handle it with one or several fingers.

It is known to provide sensing devices for operating electric hand-actuated devices, the operation of which is evaluated with the help of an evaluation circuit coupled with the electric sensing devices. Besides the use from electric sensors it is also known to detect the operation of an electric hand-held device by means of capacitive proximity sensors, in which to a detected event a device function is assigned, which is executed.

Here the disadvantage is however that the detection of a finger movement or the release of a switching event by a finger strongly depends on the hand gripping the hand-held device. In case of unfavourable position of the hand on the electric hand-held device, the hand can influence the capacitive environment of the capacitive proximity sensors in such a way that an approach of a finger at the capacitive proximity sensor can no longer reliably be detected by it. This can entail that the electric hand-held device cannot be operated anymore.

### SUMMARY

According to various embodiments, an operation of an electric hand-held device can be detected on a capacitive basis, especially guaranteeing a reliable detection of an operation process independent of the fact whether the electric hand-held device is gripped by a hand or not.

According to various embodiments, a sensor device may comprise at least one first electrode structure, which comprises at least one transmitting electrode, at least one compensation electrode and at least one reception electrode, at least one second electrode structure, which comprises at least one field transmission electrode and at least one field sensing electrode, and at least one signal transmitter for supplying the at least one transmitting electrode, the at least one compensation electrode and the at least one field transmission electrode with an electric alternating signal, wherein the at least one transmitting electrode, the at least one compensation electrode and the at least one reception electrode are arranged in such a way in relation to each other, that a first alternating electrical field emitted at the at least one transmitting electrode and a second alternating electrical field emitted at the at least one compensation electrode are coupleable into the at least one reception electrode, and the at least one field transmission electrode and the at least one field sensing electrode are arranged in such a way in relation to each other that a third alternating electrical field emitted at the at least one field transmission electrode is coupleable into the at least one field sensing electrode.

According to a further embodiment, the at least one compensation electrode and the at least one field transmission electrode can be galvanically coupled. According to a further embodiment, the sensor device can be operated in a first mode of operation and in a second mode of operation, wherein in the first mode of operation the at least one transmitting electrode, the at least one compensation electrode and the at least one field transmission electrode can be supplied with the electric alternating signal and in the second mode of operation only the at least one field transmission electrode can be supplied with the electric alternating signal. According to a further embodiment, in the first mode of operation the at least one transmitting electrode can be supplied with a first electric alternating signal and the at least one compensation electrode can be supplied with a second electric alternating signal, whereby the first electric alternating signal is phase-shifted with respect to the second electric alternating signal. According to a further embodiment, the at least one transmitting electrode, the at least one compensation electrode and the at least a field transmission electrode can be supplied with the electric alternating signal in a multiplex operation. According to a further embodiment, the sensor device may further comprise an evaluating device, which can be coupled with the first electrode structure and the second electrode structure, and wherein the evaluating device is adapted to evaluate a first electrical signal tapped at the at least one reception electrode and a second electrical signal tapped at the at least one field sensing electrode, preferably by means of a microcontroller. According to a further embodiment, the evaluating device may include an amplifying circuit, to which the first electric signal and the second electric signal can be fed, wherein the amplification of the amplifying circuit is preferably adjustable. According to a further embodiment, the first electric signal and the second electric signal can be fed in a time division multiplex method to the amplifying circuit, and wherein the amplification of the amplifying circuit is adjustable depending on the fed signal.

According to another embodiment, a method for the approach and contact detection, may comprise the following steps: —supplying at least one transmitting electrode, at least one compensation electrode and at least one field transmission electrode with an electric alternating signal, so that a first alternating electrical field emitted at the at least one transmitting electrode and a second alternating electrical field emitted at the at least one compensation electrode can be coupled into the at least one reception electrode and a third alternating electrical field emitted at the at least one field transmission electrode can be coupled into the at least one field sensing electrode, and—evaluating a first electrical signal tapped at the least one reception electrode and of a second electrical signal tapped at the least one field sensing electrode.

According to a further embodiment of the method, in a first mode of operation the at least one transmitting electrode, the at least one compensation electrode and the at least one field transmission electrode can be supplied with the electric alternating signal and in the second mode of operation only the at least one field transmission electrode can be supplied with the electric alternating signal. According to a further embodiment of the method, the electrodes can be supplied with the electric alternating signal according to a multiplex method and the first electric signal and the second electric signal are tapped in a multiplex method. According to a further embodiment of the method, the at least one transmitting electrode can be supplied with a first electric alternating signal and the at least one compensation electrode is supplied with a second electric alternating signal, whereby the first electric alternating signal is phase-shifted with respect to the second electric alternating signal.

According to yet another embodiment, a hand-held device may have a sensor device as described above.

According to this a sensor device is provided that comprises
at least one first electrode structure which comprises at least one transmitting electrode, at least one compensation electrode and at least one reception electrode, —at least one second electrode structure which comprises at least one field transmitting electrode and at least one field sensing electrode and
at least one signal transmitter for supplying the at least one transmitting electrode, the at least one compensation electrode, and the at least one field transmitting electrode with an electric alternating signal,
   in which
the at least one transmitting electrode, the at least one compensation electrode and the at least one reception electrode are arranged in such a way in relation to each other that a first alternating electrical field emitted at the at least one transmitting electrode and a second alternating electrical field emitted at the at least one compensation electrode can be coupled into the at least one reception electrode, and
the at least one field transmitting electrode and the at least one field sensing electrode are arranged in such a way in relation to each other that a third alternating electrical field emitted at the at least one field transmitting electrode can be coupled into the at least one field sensing electrode.

With the first electrode structure and the second electrode structure of the sensor device according to the various embodiments, substantially two observation areas are defined, so that e.g. in case of a mobile phone a grip of the mobile phone by a hand can be detected (with the first electrode structure) and at the same time or afterwards also an approach to the mobile phone (with the second electrode structure), e.g. of a linger of the hand gripping the mobile phone. At the same time this avoids that several sensor devices have to be provided for detecting the grip of a hand-held device by a hand and for detecting the operation of the hand-held device, which reduces construction efforts considerably.

The transmitting electrode and the compensation electrode are arranged relatively to the reception electrode in such a way that the alternating electric field emitted at the transmitting electrode and coupled into the reception electrode is almost deleted by the alternating electric field emitted at the compensation electrode and coupled into the reception electrode. This is the case when the transmitting electrode, the compensation electrode and the reception electrode are not covered by a hand. When the transmitting electrode, the compensation electrode and the reception electrode are covered by a hand, the capacitive coupling between the transmitting electrode and the reception electrode increases (by the hand), so that the effect of the alternating electric field emitted at the compensation electrode on the alternating electric field emitted at the transmitting electrode is reduced.

The field transmitting electrode and the field sensing electrode are also arranged in such a way towards each other that the electric alternating field emitted at the field transmitting electrode couples into the field sensing electrode. If an object, for example a finger approaches the field transmitting electrode and the field sensing electrode, the capacitive coupling between the field transmitting electrode and the field sensing electrode increases.

Preferably the first electrode structure and the second electrode structure can be arranged towards each other in such a way, e.g. on a hand-held device, that in case of a grip of the hand-held device, for example by a hand, substantially only the electrodes of the first electrode structure are covered. The electrodes of the second electrode structure can be covered by a finger of the hand gripping the hand-held device. If over the hand gripping the hand-held device the electric alternating field emitted at the transmitting electrode all the same couples into the field sensing electrode of the second electrode structure, a further approach to the second electrode structure by a finger entails an increase of the capacitive coupling between the field transmitting electrode and the field sensing electrode, so that the approach to the second electrode structure can be detected. If on the other hand the increase of the capacitive coupling compared to the capacitive coupling between the transmitting electrode and the field sensing electrode is very small, the sensor device according to various embodiments can be operated in two different operating modes described below.

The arrangement according to various embodiments of the electrodes of the two electrode structures in relation to each other also avoids that the capacitive environment of the second electrode structure is influenced by a hand gripping the hand-held device in such a way that a reliable detection of an approach of a finger to the second electrode structure cannot be reliably detected anymore.

The at least one compensation electrode and the at least one field transmitting electrode can be galvanically coupled. For supplying the compensation electrode or the field transmitting electrode with an electric alternating signal thus no separate signal generators have to be provided. The production effort can thus be reduced considerably.

The sensor device can be operated in a first mode of operation and in a second mode of operation. In the first mode of operation the at least one transmitting electrode, the at least one compensation electrode and the at least one field transmitting electrode can be supplied with an electric alternating signal and in the second mode of operation only the at least one field transmitting electrode can be supplied with the electric alternating signal.

It has proved advantageous to supply, in the first mode of operation, the at least one transmitting electrode with a first electric alternating signal and to supply the at least one compensation electrode with a second electric alternating signal, in which the first electric alternating signal is phase-shifted with respect to the second electric alternating signal. Preferably the second electric alternating signal may have a lower amplitude than the first electric alternating signal.

The at least one transmitting electrode, the at least one compensation electrode and the at least one field transmitting electrode can be supplied with the electric alternating signal in a multiplex method (time-division multiplex method and/or frequency multiplex method and/or code multiplex method).

The sensor device can further include an evaluating device, which can be coupled with the first electrode structure and the second electrode structure, wherein the evaluating device is adapted to evaluate a first electrical signal tapped at the at least one reception electrode and a second electrical signal tapped at the at least one field sensing electrode. The evaluating device advantageously includes a microcontroller.

It is advantageous if the evaluating device includes an amplifying circuit to which the first electric signal and the second electric signal can be fed, the amplification of the amplifying circuit being preferably adjustable.

The first electric signal and the second electric signal can preferably be fed to the amplifying circuit in a time-division multiplex method, the amplification of the amplifying circuit being adjustable depending on the signal supplied.

Moreover a method for approach and contact detection is provided by various embodiments, which includes the following steps:
supplying at least one transmitting electrode, at least one compensation electrode and at least one field transmitting electrode with an electric alternating signal, so that an alternating electrical field emitted at the at least one transmitting electrode and a second alternating electrical field emitted at the at least one compensation electrode can be coupled into the at least one reception electrode, and a third alternating electrical field emitted at the at least one field transmitting electrode can be coupled into the at least one field sensing electrode, and
evaluating a first electrical alternating signal tapped at the least one reception electrode and of a second electrical tapped at the least one field sensing electrode.

In a first mode of operation the at least one transmitting electrode, the at least one compensation electrode and the at least one field transmitting electrode can be supplied with the electric alternating signal and in a second mode of operation only at least one field transmitting electrode can be supplied with the electric alternating signal.

The electrodes to which an electrical alternating signal is supplied can be supplied with the electric alternating signal according to a multiplex method and the first electric signal and the second electric signal can be tapped in a multiplex method.

The at least one transmitting electrode can be supplied with a first electric alternating signal and the at least one compensation electrode can be supplied with a second electric alternating signal, the first electric alternating signal being phase shifted with respect to the second electric alternating signal.

Moreover various embodiments provide a hand-held device which may comprise a sensor device as described above. The hand-held device can be an electrical hand-held device, especially a computer mouse, mobile phone, remote control, input or control means for game consoles, minicomputer or similar.

### BRIEF DESCRIPTION OF THE DRAWINGS

Further features and characteristics as well as concrete embodiments result from the following description in connection with the drawing. The figures show:

FIG. 1 a first usage scenario with two electrode structures according to an embodiment on one electric hand-held device, which is gripped by a hand;

FIG. 2 second usage scenario with two electrode structures according to an embodiment on one electric hand-held device, which is gripped by a hand;

FIG. 3 a third usage scenario with two electrode structures according to an embodiment on one electric hand-held device, which is not gripped by a hand;

FIG. 4 a fourth usage scenario with two electrode structures according to an embodiment on one electric hand-held device, which is not gripped by a hand;

FIG. 5 the influence of a hand gripping an electrical hand-held device on the signal level at a field sensing electrode with an approached finger on the one hand and without an approached finger on the other hand;

FIG. 6 a block diagram of a first embodiment of a sensor device;

FIG. 7 a block diagram of a second embodiment of a sensor device;

FIG. 8 a block diagram of a third embodiment of the sensor device, wherein the second electrode structure comprises several areas;

FIG. 9 a block diagram of a fourth embodiment of a sensor device with several areas of the second electrode structure;

FIG. 10 a block diagram of a fifth embodiment of a sensor device with a plurality of areas of the second electrode structure, in which with the plurality of areas a slide control and/or a multiple button system can be realized;

FIG. 11 a block diagram of a sixth embodiment of the sensor device, wherein the second electrode structure comprises a plurality of areas with which a slide control and/or a multiple button system can be realized; and

FIG. 12 a principle representation of a sensor device according to an embodiment for realizing a slide control and a rotary regulator, in which the sensor resolution can be increased in case of a fixed number of transmission channels.

### DETAILED DESCRIPTION

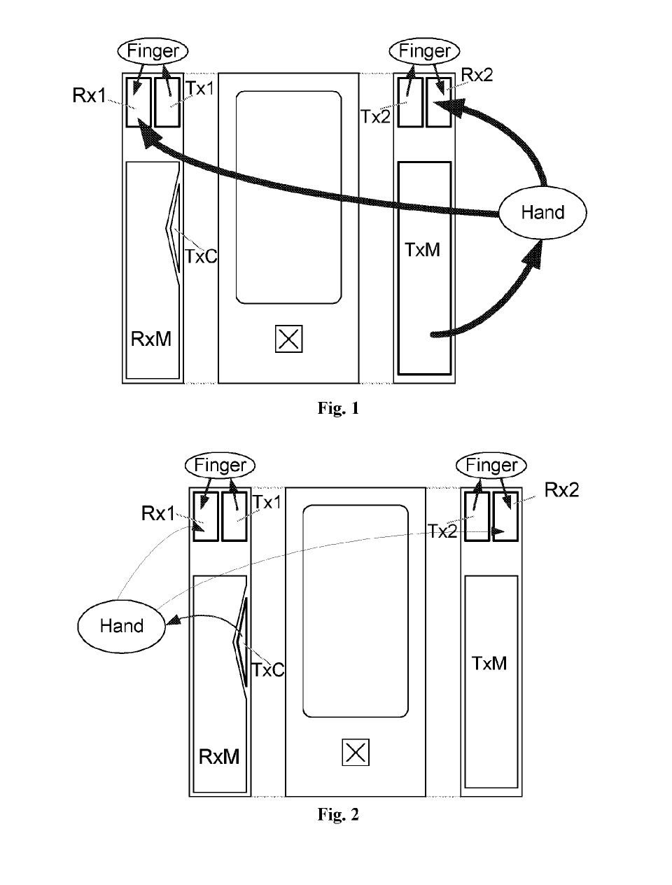

FIG. 1 shows an electrical hand-held device, for example a mobile phone, on which a first electrode structure and a second electrode structure are arranged. The first electrode structure includes a transmitting electrode TxM, a compensation electrode TxC and a reception electrode RxM. The second electrode structure includes two electrode pairs Rx1, Tx1 or Rx2; Tx2.

The first electrode structure is provided for detecting the grip of the electric hand-held device by a hand. The second electrode structure or the two electrode pairs Rx1, Tx1 and Rx2, Tx2 are provided for detecting the approach of a finger to the respective electrode pair. The electrodes Tx1, Tx2 (field transmission electrodes) are operated as transmission electrodes, at which an alternating electrical field can be irradiated. The electrodes Rx1 and Rx2 (field sensing electrodes) are operated as reception electrodes, into which the alternating electrical field irradiated by the respective field transmitting electrode Tx1, Tx2 can be coupled, as soon as the finger has come sufficiently near to the respective electrode pair. The coupling is done by means of the approaching the finger to the respective electrode pair.

At the transmitting electrode TxM also an alternating electrical field can be emitted, which can be coupled in case of a grip of the electric hand-held device by a hand over the hand into the reception electrode RxM. At the compensation electrode TxC an alternating electrical field is emitted, which can be coupled into the reception electrode RxM. If the hand-held device is not gripped by a hand, the alternating electric field emitted at the transmitting electrode TxM is almost deleted by the alternating electric field emitted at the compensation electrode TxC, so that the electric current in the reception electrode RxM is very small.

Preferably the phasing of the alternating electric field emitted at the compensation electrode TxC can be different from the phasing of the alternating electric field emitted at the transmitting electrode TxM. Preferably the alternating electric field emitted at the compensation electrode TxC may present a phase shift of about 180° as to the electric alternating field emitted at the transmitting electrode TxM.

If the electric hand-held device is gripped by a hand, a strong electric coupling between the transmitting electrode TxM over the hand to the field sensing electrodes Rx1 or Rx2 results. In case of an approach of a finger to the electrode pairs Tx1, Rx1 or Tx2, Rx2 moreover the alternating electric field emitted at the respective field transmitting electrode Tx1 or Tx2 is coupled over the finger into the respective field sensing electrode Rx1 or Rx2. The coupling over the finger entails a level rise of the electric current flowing in the respective field sensing electrode Rx1 or Rx2, which is indicative for the approach of a finger to the respective electrode pair Rx 1, Tx1 or Rx2, Tx2.

As also the alternating electric field emitted by the transmitting electrode TxM over the hand couples into the field sensing electrodes Rx1 or Rx2, an unfavourable grip of the electric hand-held device by a hand may entail that the portion of the alternating electric field coupled over the hand into the field sensing electrodes Rx1 and Rx2 is quite bigger than the portion of the alternating electric field coupled over the finger into the field sensing electrodes Rx1 or Rx2, which is emitted at the respective field transmitting electrode Tx1 or Tx2. This may entail that in a hand-held device which is gripped by a hand, the level rise of the current flowing in the field sensing electrodes Rx1 or Rx2 in case of an approach of a finger to the respective electrode pair Rx1, Tx1 or Rx2, Tx2 is only very small, which my entail that an approach to the respective electrode pair may not be reliably detected.

In order to avoid this it is advantageous, at first to detect the grip of the electric hand-held device by a hand with the help of the first electrode structure TxM, TxC, RxM and, after successful detection to deactivate at least the transmitting electrode TxM, so that after successful detection of the grip by a hand at the transmitting electrode TxM no alternating electrical field is emitted anymore which could be coupled over the hand into the field sensing electrodes Rx 1 or Rx2.

FIG. 2 shows an electrical hand-held device with a first electrode structure and a second electrode structure, in which the electric hand-held device is gripped by a hand. In the example shown in FIG. 2 the transmitting electrode TxM of the first electrode structure is inactive, whereas the compensation electrode TxC of the first electrode structure is active, so that at it an alternating electrical field is emitted. As the compensation electrode TxC is small if compared to the transmitting electrode TxM, the alternating electric field emitted at the compensation electrode TxC only has a very small effect on the electric current flowing in the field sensing electrodes Rx1 or Rx2. In order to detect with certainty the approach of a finger to the electrode pairs Tx1, Rx1 or Tx2, Rx2, the compensation electrode TxC must not be deactivated.

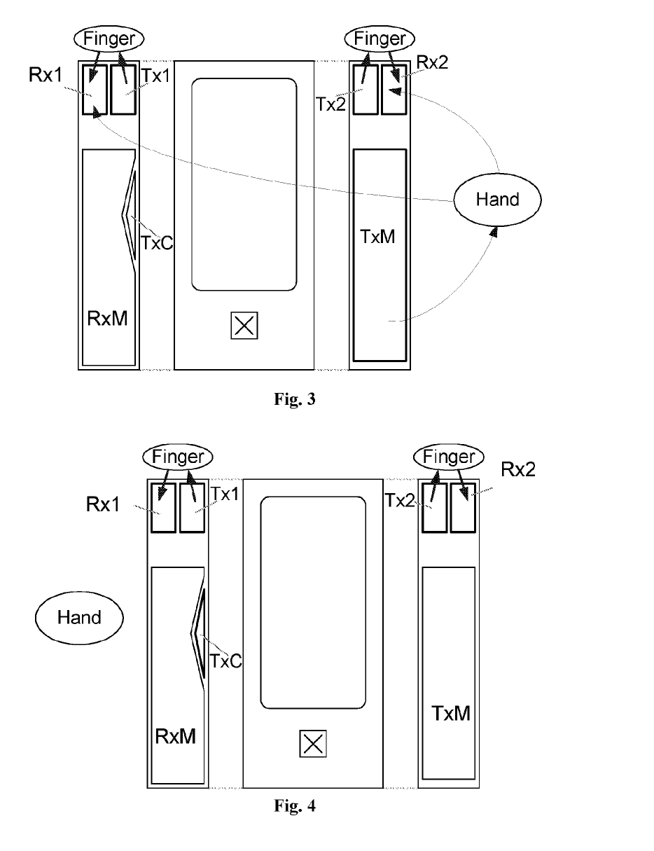

FIG. 3 shows an electrical hand-held device with a first electrode structure and a second electrode structure, in which the electric hand-held device is not gripped by a hand. The hand here is only approaching the hand-held device. Like in FIG. 1 here too the transmitting electrode TxM of the first electrode structure is active, i.e. at the transmitting electrode TxM an alternating electrical field is emitted. As however the electric hand-held device is not gripped by the hand, the capacitive coupling of the transmitting electrode TxM over the hand to the field sensing electrodes Rx1 or Rx2 is only very small.

A finger approaching the electrode pairs Rx1, Tx1 or Rx2, Tx2 here again entails that the alternating electric field emitted at the respective field transmitting electrode Tx1 or Tx2 couples in over the finger into the field sensing electrode Rx1 or Rx2. The alternating electric field coupled into the respective field sensing electrode Rx1 or Rx2 over the finger entails in the respective field sensing electrode a significant level rise of the electric current flowing in the respective field sensing electrode. As the capacitive coupling between the transmitting electrode TxM and the field sensing electrodes Rx1 or Rx2 is very small, this capacitive coupling has only a small effect on the level rise of the current flowing in the respective field sensing electrode. An approach of a finger to the electrode pairs Rx1, Tx1 or Rx2, Tx2 can thus precisely be detected even in case of active transmitting electrode TxM.

FIG. 4 shows an electrical hand-held device with a first electrode structure and a second electrode structure, in which the electric hand-held device is not gripped by a hand and in which the compensation electrode TxC is active, whereas the transmitting electrode TxM is inactive. Like in FIG. 3 the hand-held device is approached here too. As already explained in regard to FIG. 2, the alternating electric field emitted at the compensation electrode TxC, which compared to the transmitting electrode TxM is small, and coupled over the hand into the field sensing electrode Rx1 or Rx2, has almost no effect on the electric current flowing in the respective field sensing electrode Rx1 or Rx2. The approach of a finger to the electrode pairs Rx1, Tx1 or Rx2, Tx2 can therefore precisely be ascertained.

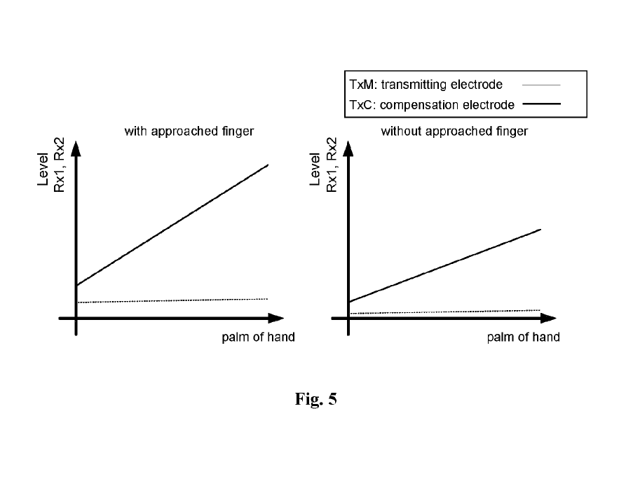

FIG. 5 shows two diagrams which show the influence of the hand once in case of an approaching finger and once without approaching finger on the signal level of the current flowing in the field sensing electrode Rx1 or Rx2.

The continuous line shows the level depending on the hand, when the transmitting electrode TxM is active. As can be recognized here, in case of active transmitting electrode TxM the area of the hand has a strong effect on the signal level in the field sensing electrode Rx1 and Rx2. The influence of the hand in case of active transmitting electrode TxM on the signal level is great, independent of the fact if a finger is near the second electrode structure.

The dotted line shows the influence of a gripping hand on the signal level in the field sensing electrode Rx1 or Rx2, when the compensation electrode TxC is active, whereas the transmitting electrode TxM is inactive. As can be seen, the area of the hand hardly influences the signal level in the field sensing electrodes Rx1 or Rx2 when the compensation electrode TxC is active whereas the transmitting electrode TxM is inactive.

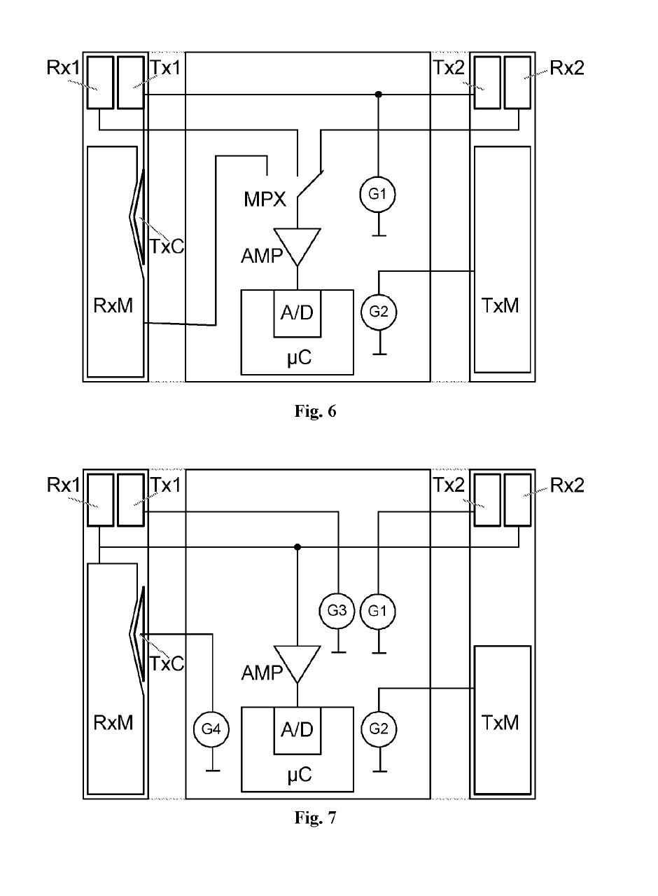

FIG. 6 shows a block diagram of a first embodiment of the sensor device. The evaluating device includes a multiplexer MPX, an amplifier AMP, a microcontroller μC and two signal generators G1 and G2. The field sensing electrodes Rx1, Rx2 and the reception electrode RxM are coupled with the multiplexer MPX. The signals tapped at the field sensing electrodes Rx1, Rx2 and at the reception electrode RxM are fed over the multiplexer MPX in the time division multiplex method to the amplifier AMP or to the microcontroller μC. Alternatively the measured signals can be fed each time to different amplifiers, the respective amplified signal being fed to the microcontroller μC.

The amplifier AMP may be preferably adjustable in its amplification during operation, so that the amplification can be optimized for the respective signal fed to the amplifier AMP depending on the position of the multiplexer MPX.

The signal generator G1 generates an electrical alternating signal, which is supplied to the field transmission electrodes Tx1, Tx2 and the compensation electrode TxC. The electric alternating signal generated by the signal generator G1 is set in such a way that in the first mode of operation, in which the gripping of a hand-held device by a hand is detected, it acts as a compensation signal, as described referring to FIG. 1.

The electric alternating signal generated by the signal generator G1 can be in the first mode of operation preferably phase-shifted with respect to the electric alternating signal generated by the second signal generator G2, which is supplied to the transmitting electrode TxM. Particularly preferably the electric alternating signal generated by the signal generator G1 presents a phase shift of around 180° with respect to the electric alternating signal from the second signal generator G2. Moreover it is advantageous if the electric alternating signal provided by the signal generator G1 is slightly dampened, so that the alternating electric field emitted by the transmitting electrode TxM is not completely deleted by the alternating electric field emitted by the compensation electrode TxC.

The field transmission electrodes Tx1, Tx2 in the embodiment shown in FIG. 6 are galvanically coupled with the compensation electrode TxC. In this way the production expenditure for producing the sensor device according to various embodiments is kept low, because for the operation of the compensation electrode TxC no own signal generator needs to be provided.

After the detection of the gripping of the hand-held device by a hand, the sensor device is operated in a second mode of operation, in which an approach to the electrode pairs Rx1, Tx1 or Rx2, Tx2 by a finger is detected. If for example a finger approaches the electrode pair Tx 1, Rx 1, the alternating electric field emitted at the field transmitting electrode Tx1 is coupled over the finger into the field sensing electrode Rx1. The alternating electric field coupled into the field sensing electrode Rx1 entails a level change of the electric current flowing in the field sensing electrode Rx 1. The electric current flowing in the field sensing electrode Rx1 or the level change of the electric current flowing in the field sensing electrode Rx1 is indicative for an approaching finger to the electrode pair Rx1, Tx1.

If the sensor device is in the second mode of operation, the second signal generator G2 is preferably deactivated, so that no coupling of an alternating electric field emitted by the transmitting electrode TxM over the hand into the field sensing electrodes Rx1 or Rx2 is possible. In this way the influence of a hand gripping the electric hand-held device on the detection of an approach of a finger to the electrode pairs Rx1, Tx1 or Rx2, Tx2 is almost completely eliminated.

As an alternative to deactivating the second signal generator G2 in the second mode of operation, also the phase of the signal provided by the first signal generator G1 or by the second signal generator G2 can be modified, so that the signals of the signals provided by the signal generators G1 and G2 are substantially in phase. This alternative is advantageous above all if the electrodes Tx1, Tx2 and TxM in substance have the same electrode surface or when the electrode surface of the electrodes Tx1 and Tx2 is greater than the electrode surface of the electrode TxM.

FIG. 7 shows a block diagram of a second embodiment of the sensor device. In this embodiment for each transmitting electrode TxM, Tx1, Tx2 and TxC an own signal generator G1, G2, G3 or 04 is provided. The receiving electrodes or field sensing electrodes RxM or Rx1 and Rx2 are here parallelly operated. The signal generators G1, 02, G3 or 64 are activated sequentially, so that at every moment in time exactly one signal generator is active. The signal generators G1, G2, G3 or G4 can also be parallelly operated, preferably every signal generator providing an electric alternating signal with a different frequency, i.e. the signal generators are operated in the frequency multiplex method. The evaluating device or the microcontroller μC can split the RxM signal tapped at the receiving electrodes or field sensing electrodes Rx1 and Rx2 into its frequency components.

Alternatively also only one signal generator can be provided, which is coupled with the transmission electrodes TxM, Tx1, Tx2 or TxC by means of a multiplexer. In the first mode of operation of the sensor device however the signal generators G2 and G4 are parallelly operated, in order to detect a gripping of an electric hand-held device by a hand. In the first mode of operation the electric alternating signal generated by the signal generator G4 is equally preferably phase-shifted with respect to the electric alternating signal generated by the signal generator G2.

In the second mode of operation of the sensor device preferably only the signal generators G1 and G3 are operated. The signal generators G2 and G4 are inactive in the second mode of operation.

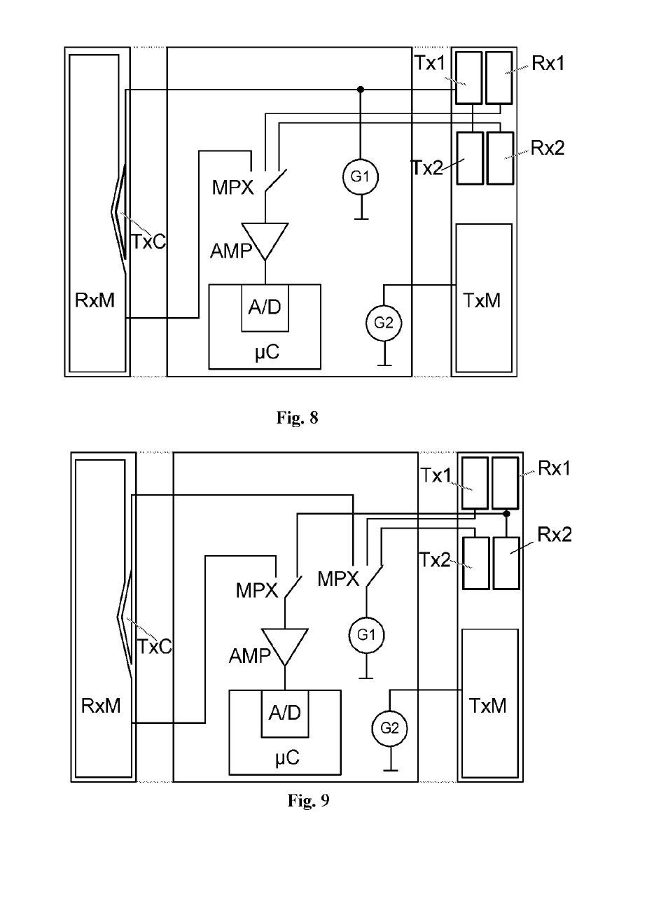

FIG. 8 shows a block diagram of the sensor device according to an embodiment, in which the second electrode structure comprises several areas, with which a so-called slide control can be realized. Each area has an electrode pair consisting of a field transmitting electrode and a field sensing electrode. The operation mode of the sensor device here corresponds substantially to the operation mode as described referring to FIG. 6. The single areas of the second electrode structure, i.e. the electrode pairs Tx1, Rx1 or Tx2, Rx2 are arranged here however side by side, so that the movement of a finger along the single areas can be detected. Because of the temporal sequence of the activation of the single areas by a finger moving over the areas, the direction of the finger movement can be detected. Of course also more than the two areas shown in FIG. 8 can be provided.

FIG. 9 shows a block diagram of the sensor device according to an embodiment with several areas of the second electrode structure, in which, unlike the sensor device shown in FIG. 8, the field sensing electrodes Rx1 and Rx2 are parallelly operated, whereas the field transmission electrodes Tx1, Tx2 are supplied with an electric alternating signal by means of a multiplexer in sequential sequence.

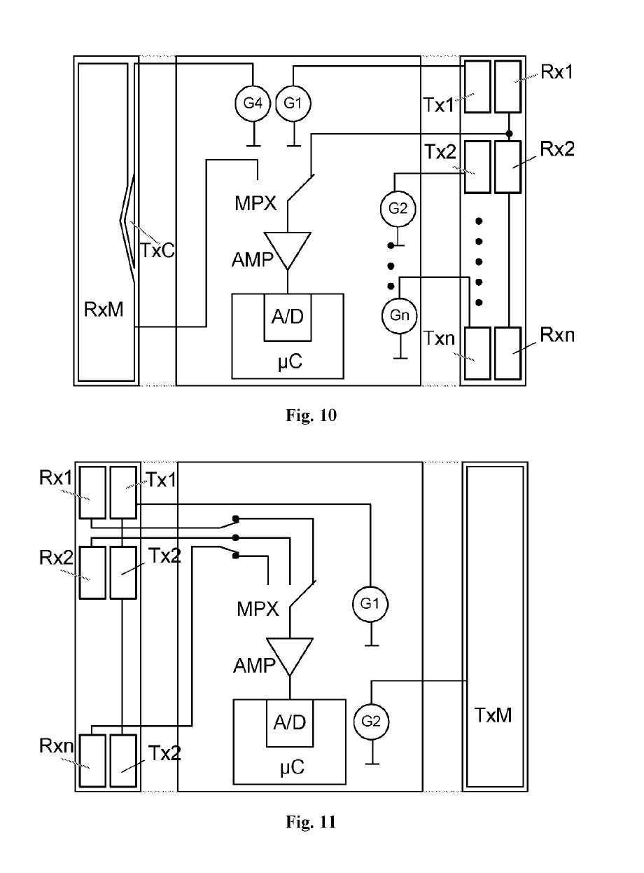

FIG. 10 shows a block diagram of a sensor device according to an embodiment with a plurality of areas of the second electrode structure, in which with the plurality of areas a slide control or a multiple button system can be realized.

The field transmission electrodes Tx1, Tx2 to Txn are supplied each time with an electric alternating signal, which each time is provided by a signal generator G1, G2 to G. The field sensing electrodes Rx1, Rx2 to Rxn and RxM are parallelly operated, while in the second mode of operation each time only one signal generator G1, G2 to G3 is active. For the operation of the sensor device in the first mode of operation the signal generators G1, G2 to G are parallelly operated, so that the field transmission electrodes Tx1, Tx2 to Txn form a large transmitting electrode TxM which serves as transmitting electrode for the detection of the gripping of a hand-held device by a hand.

According to the embodiment shown in FIG. 10 of the sensor device, the field transmission electrodes Tx1 to Txn are both used as trans mission electrodes for the second mode of operation and as transmission electrodes for the first mode of operation. In this way the construction expenditure can be reduced considerably. Another reduction of construction expenditure can be reached by providing only one signal generator for the operation of the field transmission electrodes Tx1 to Txn, which in the time-division multiplex method is coupled with the field transmission electrodes Tx1 to Txn, in which for the operation of the field transmission electrodes Tx1 to Txn in the first mode of operation all the field transmission electrodes are coupled with the signal generator.

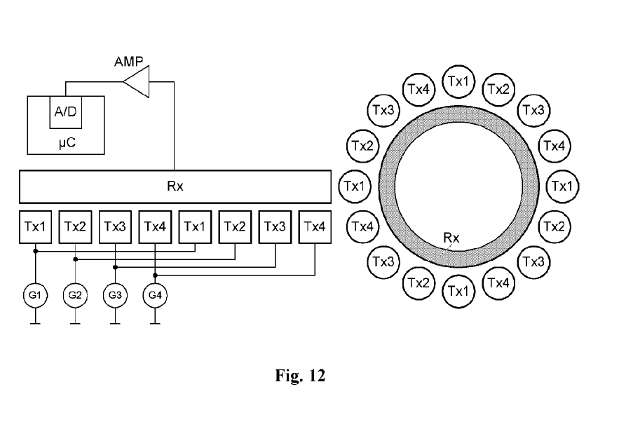

FIG. 11 shows a block diagram of the sensor device according to an embodiment, wherein the second electrode structure comprises a plurality of areas, with which a slide control and/or a multiple button system can be realized. The field transmission electrodes Tx1 to Txn are operated here parallelly, i.e. supplied with an electric alternating signal of a single signal generator G1, whereas the field sensing electrodes Rx1 to Rxn are coupled in the time-division multiplex method with the amplifier AMP or with the microcontroller μC.

For the operation of the sensor device in the first mode of operation the field sensing electrodes Rx1 to Rxn can be parallelly operated, so that the field sensing electrodes Rx1 to Rxn form a large reception electrode RxM for the detection of the gripping of a hand-held device by a hand. For the operation of the sensor device in the first mode of operation an additional compensation electrode TxC can be provided (in FIG. 11 not shown). Alternatively also the field transmission electrodes Tx1 to Txn can be operated in the first mode of operation as compensation electrode. In case of the operation of the field transmission electrodes Tx1 to Txn as compensation electrode in the first mode of operation, the electric alternating signal generated by the signal generator G1 has a phase that is different from that of the electric alternating signal generated by the signal generator G2.

According to the embodiment shown in FIG. 11 of the sensor device, the field transmission electrodes Tx1 to Txn and the field sensing electrodes Rx1 to Rxn are both used in the first mode of operation for detecting a grip and in the second mode of operation for detecting the approach of a finger to an electrode pair. In such a way the construction expenditure for the production of corresponding electrode surfaces on an electric hand-held device can be maintained low.

FIG. 12 shows a principle representation of the sensor device according to an embodiment for realization of a slide control or a rotary regulator, in which the sensor resolution can be increased in case of a fixed number of transmission channels.

The slide control or rotary regulator presents each four different transmission electrodes Tx1 to Tx4 and a common reception electrode Rx. Because of the spatial arrangement of the transmission electrodes Tx1 to Tx4 in relation to each other, as shown in FIG. 12, the direction of a finger moving in relation to the transmission electrodes can be detected. A localization is however not possible, since a transmitting electrode is at the same time active at several places. For example in the rotary regulator shown in FIG. 12 the transmitting electrode Tx1 is active both on top and at the bottom and on the left and on the right at the same time. A distinction as to which of the four transmission electrodes Tx1 a linger is approaching, cannot be made here.

A localization can be however reached for example by providing for the slide control eight different transmission electrodes and for the rotary regulator 16 different transmission electrodes. Alternatively the electrodes can also be operated in a time-division multiplex method. For example the electrodes shown in the slide control Tx1 in a time-division multiplex method can be supplied with the electric alternating signal of the signal generator G1, so that each time only one of the two transmission electrodes Tx1 is active at a moment.

What is claimed is:

1. A sensor arrangement for a hand-held device, comprising
at least one first electrode structure, which comprises at least one transmitting electrode, at least one compensation electrode and at least one reception electrode,
at least one second electrode structure, which comprises at least one field transmission electrode and at least one field sensing electrode, and
at least one signal transmitter for supplying the at least one transmitting electrode, the at least one compensation electrode and the at least one field transmission electrode with an electric alternating signal,
wherein
the at least one transmitting electrode, the at least one compensation electrode and the at least one reception electrode are arranged in such a way in relation to each other, that a first alternating electrical field between the at least one transmitting electrode and the at least one reception electrode can be established and a second alternating electrical field between the at least one compensation electrode and the at least one reception electrode can be established, and
the at least one field transmission electrode and the at least one field sensing electrode are arranged in such a way in relation to each other and to the at least one transmitting and compensation electrodes that a third alternating electrical field between the at least one field transmission electrode and the at least one field sensing electrode can be established and that a gripping of the hand-held device by a hand can cause a coupling of at least one of said first and second alternating fields to said at least one field sensing electrode.

2. Sensor arrangement for a hand-held device according to claim 1, wherein the at least one compensation electrode and the at least one field transmission electrode are galvanically coupled.

3. Sensor arrangement for a hand-held device according to claim 1, wherein the sensor device can be operated in a first mode of operation and in a second mode of operation, wherein in the first mode of operation the at least one transmitting electrode, the at least one compensation electrode and the at least one field transmission electrode can be supplied with the electric alternating signal and in the second mode of operation only the at least one field transmission electrode can be supplied with the electric alternating signal.

4. Sensor arrangement for a hand-held device according to claim 3, wherein in the first mode of operation the at least one transmitting electrode can be supplied with a first electric alternating signal and the at least one compensation electrode can be supplied with a second electric alternating signal, whereby the first electric alternating signal is phase-shifted with respect to the second electric alternating signal.

5. Sensor arrangement for a hand-held device according to claim 1, wherein the at least one transmitting electrode, the at least one compensation electrode and the at least a field transmission electrode are supplied with the electric alternating signal in a multiplex operation.

6. Sensor arrangement for a hand-held device according to claim 1, further comprising an evaluating device, which can be coupled with the first electrode structure and the second electrode structure, and wherein the evaluating device is adapted to evaluate a first electrical signal tapped at the at least one reception electrode and a second electrical signal tapped at the at least one field sensing electrode.

7. Sensor arrangement for a hand-held device according to claim 6, wherein the evaluating device includes an amplifying circuit, to which the first electric signal and the second electric signal can be fed.

8. Sensor arrangement for a hand-held device according to claim 7, wherein the first electric signal and the second electric signal can be fed in a time division multiplex method to the amplifying circuit, and wherein the amplification of the amplifying circuit is adjustable depending on the fed signal.

9. A method for the approach and contact detection of a hand-held device, comprising the following steps:
supplying at least one transmitting electrode, at least one compensation electrode and at least one field transmission electrode with an electric alternating signal, so that a first alternating electrical field emitted at the at least one transmitting electrode and a second alternating electrical field emitted at the at least one compensation electrode can be coupled into the at least one reception electrode and a third alternating electrical field emitted at the at least one field transmission electrode can be coupled into the at least one field sensing electrode, wherein the at least one transmitting electrode, the at least one compensation electrode and the at least one field sensing electrode are arranged such that a gripping of the hand-held device by a hand can cause a coupling of at least one of said first and second alternating fields said at least one field sensing electrode, and
evaluating a first electrical signal tapped at the least one reception electrode and of a second electrical signal tapped at the least one field sensing electrode.

10. Method according to claim 9, wherein in a first mode of operation the at least one transmitting electrode, the at least one compensation electrode and the at least one field transmission electrode are supplied with the electric alternating signal and in the second mode of operation only the at least one field transmission electrode is supplied with the electric alternating signal.

11. Method according to claim 9, wherein the electrodes are supplied with the electric alternating signal according to a multiplex method and the first electric signal and the second electric signal are tapped in a multiplex method.

12. Method according to claim 9, wherein the at least one transmitting electrode is supplied with a first electric alternating signal and the at least one compensation electrode is supplied with a second electric alternating signal, whereby the first electric alternating signal is phase-shifted with respect to the second electric alternating signal.

13. Hand-held device having a sensor arrangement, the sensor arrangement comprising:
at least one first electrode structure, which comprises at least one transmitting electrode, at least one compensation electrode and at least one reception electrode,
at least one second electrode structure, which comprises at least one field transmission electrode and at least one field sensing electrode, and
at least one signal transmitter for supplying the at least one transmitting electrode, the at least one compensation electrode and the at least one field transmission electrode with an electric alternating signal, wherein
the at least one transmitting electrode, the at least one compensation electrode and the at least one reception electrode are arranged in such a way in relation to each other, that a first alternating electrical field between the at least one transmitting electrode and the at least one reception electrode can be established and a second alternating electrical field between the at least one compensation electrode and the at least one reception electrode can be established, and
the at least one field transmission electrode and the at least one field sensing electrode are arranged in such a way in relation to each other and to the at least one transmitting and compensation electrodes that a third alternating electrical field between the at least one field transmission electrode and the at least one field sensing electrode can be established and that a gripping of the hand-held device by a hand can cause a coupling of at least one of said first and second alternating fields to said at least one field sensing electrode.

14. Hand-held device according to claim 13, comprising a plurality of signal transmitters, wherein each signal transmitter optionally operates at a different frequency, wherein said at least one transmitting electrode and said at least one field transmission electrode are coupled with different signal transmitters.

15. Hand-held device according to claim 13, wherein the at least one compensation electrode and the at least one field transmission electrode are galvanically coupled.

16. Hand-held device according to claim 13, wherein the sensor device can be operated in a first mode of operation and in a second mode of operation, wherein in the first mode of operation the at least one transmitting electrode, the at least one compensation electrode and the at least one field transmission electrode can be supplied with the electric alternating signal and in the second mode of operation only the at least one field transmission electrode can be supplied with the electric alternating signal.

17. Hand-held device according to claim 16, wherein in the second mode of operation only the at least one field transmission electrode and the at least one compensation electrode can be supplied with a respective electric alternating signal.

18. Hand-held device according to claim 16, wherein in the first mode of operation the at least one transmitting electrode can be supplied with a first electric alternating signal and the at least one compensation electrode can be supplied with a second electric alternating signal, whereby the first electric alternating signal is phase-shifted with respect to the second electric alternating signal.

19. Hand-held device according to claim 13, wherein the at least one transmitting electrode, the at least one compensation electrode and the at least a field transmission electrode are supplied with the electric alternating signal in a multiplex operation.

20. Hand-held device according to claim 13, further comprising an evaluating device, which can be coupled with the first electrode structure and the second electrode structure, and wherein the evaluating device is adapted to evaluate a first electrical signal tapped at the at least one reception electrode and a second electrical signal tapped at the at least one field sensing electrode by means of a microcontroller.

21. Hand-held device according to claim 20, wherein the evaluating device includes an amplifying circuit, to which the first electric signal and the second electric signal can be fed, wherein the amplification of the amplifying circuit is adjustable.

22. Hand-held device according to claim 21, wherein the first electric signal and the second electric signal can be fed in a time division multiplex method to the amplifying circuit, and wherein the amplification of the amplifying circuit is adjustable depending on the fed signal.

23. Sensor arrangement for a hand-held device according to claim 1, comprising a plurality of signal transmitters, wherein each signal transmitter optionally operates at a different frequency, wherein said at least one transmitting electrode and said at least one field transmission electrode are coupled with different signal transmitters.

24. Sensor arrangement for a hand-held device according to 3, wherein in the second mode of operation only the at least one field transmission electrode and the at least one compensation electrode can be supplied with a respective electric alternating signal.

25. Sensor arrangement for a hand-held device according to claim 1, further comprising an evaluating device, which can be coupled with the first electrode structure and the second electrode structure, and wherein the evaluating device is adapted to evaluate a first electrical signal tapped at the at least one reception electrode and a second electrical signal tapped at the at least one field sensing electrode by means of a microcontroller.

26. Sensor arrangement for a hand-held device according to claim 6, wherein the evaluating device includes an amplifying circuit, to which the first electric signal and the second electric signal can be fed, wherein the amplification of the amplifying circuit is adjustable.
